(19) United States
(12) Patent Application Publication
(10) Pub. No.: US 2013/0091666 A1
(43) Pub. Date: Apr. 18, 2013

(54) HINGE ARRANGEMENT

(71) Applicants: Ola Carmonius, Malmo (SE); Magnus Lindvall, Lund (SE)

(72) Inventors: Ola Carmonius, Malmo (SE); Magnus Lindvall, Lund (SE)

(73) Assignee: SONY ERICSSON MOBILE COMMUNICATIONS AB, Lund (SE)

(21) Appl. No.: 13/129,534

(22) PCT Filed: Jun. 16, 2010
(86) PCT No.: PCT/EP2010/058489

§ 371 Date: Dec. 16, 2011

(51) Int. Cl. F16C 11/10

(52) U.S. Cl. CPC F16C 11/103
USPC 16/328

(57) ABSTRACT

The present invention relates to a hinge arrangement 1 for opening and closing two portions which are connected to said hinge arrangement 1 at one end of the respective portion. The hinge arrangement 1 comprises an element 5a having a first friction surface 6a and a plate 7 having a second friction surface 8a. The first friction surface 6a is adapted to slide against said second friction surface 8a. A resilient member 9a cooperates with said element 5a. The second friction surface 8a is arranged around, or partly around, an axis 10a through the element 5a such that the second friction surface 8a comprises a first part 11a being arranged at a first level 12 along the axis 10a, and a second part 13a being arranged extending from said first level 12 to a second level 14 along the axis 10a.

### TECHNICAL FIELD

The present invention relates to a hinge arrangement for opening and closing two portions in accordance with the preamble of claim 1.

### BACKGROUND

Many modern models of electrical devices comprise two portions, usually a display portion and a keyboard portion. Such devices may include mobile phones, gaming terminals, disc-players, etc.

These portions are usually connected by means of a hinge, which may allow them to open, e.g. in 360 degrees.

In a 360 degree hinge, one key feature is to have mechanically stable positions for the upper portion with respect to the lower portion. It is important that the upper portion does not rotate unintentionally during a specified use case.

For example, if an upper portion comprises a display, to maintain a chosen display angle there is basically two common approaches, fixed predefined positions or continuous friction, so called “free stop”. Fixed predefined position uses a cam mechanism, which tend to be imprecise, i.e. poor quality perception. Such an approach also reduces the possibility to freely choose view angle.

A pure friction solution with high free stop torque is difficult to design in small spaces since high spring forces are needed.

### SUMMARY

One object of the invention is to provide a hinge arrangement allowing two portions relatively each to withstand theirs relative position with respect to each other when a force from a finger is pointing with a force at and against one of the portions, as well as withstanding the dead-weight from the one portion.

Another object of the invention is to provide a mechanism of a hinge arrangement which has small dimensions and simultaneously may have a high torque.

Those and other objects are achieved by the hinge arrangement according to claim 1.

The present invention relates to a hinge arrangement for opening and closing two portions being connected to said hinge arrangement. The hinge arrangement comprises an element having a first friction surface and a plate having a second friction surface. Said first friction surface being adapted to slide against said second friction surface, and a resilient member cooperating with said element.

In accordance with the invention, the second friction surface is arranged around, or partly around, an axis through the element such that the second friction surface comprises a first part being arranged at a first level along the axis, and a second part being arranged extending from said first level to a second level along the axis.

When the surfaces are being pressed against each other a friction force is generated between said surfaces upon sliding of the surfaces against each other. The friction force is direct related to a torque within the hinge arrangement when said portions are being opened or closed relatively to each other.

An advantage of the invention is that the hinge arrangement provides a stable mechanism such that the one portion may be remained in a position with respect to the other portion, providing a torque which when the one portion is being pushed or pointed at, the torque upon the opening between the portions is greater than another opposite torque relating to closure of said portions.

The present invention further aims to solve the problem with above mentioned techniques and addresses the free stop issue. The present invention provides a compact, robust, free stop solution that generates high torque.

According to one embodiment of the present invention, the second friction surface may be facing the element. The element is arranged to interact with the plate via their respective first and second friction surfaces. The friction surfaces are arranged such that said surfaces are facing towards each other.

According to another embodiment of the present invention, the first friction surface may be adopted to slide against the first part of the second friction surface with a constant torque applied to the hinge arrangement. The friction generated between said friction surfaces results in said torque.

According to another embodiment of the present invention, the first friction surface may be adopted to slide against the second part of the second friction surface with an increasing torque applied to the hinge arrangement. The increasing in the torque has the effect that the one portion may remain in a position allowing it to be pointed at. The one portion may e.g. be a touch screen. The increased torque may then prevent the screen from falling back towards the other portion of said two portions upon touching the portion comprising the screen. The touch screen may e.g. be a resistive touch screen or a capacitive touch screen.

According to another embodiment of the present invention, the second friction surface may comprise a third part. The first part, the second part and the third part are aligned after each other. The third part enters in to use when the hinge arrangement continue opening after approximately 160-200 degrees. Upon a continuation of opening of the hinge arrangement, the hinge arrangement will pass said degrees. This has the effect that a respective outer part of the portions approaches each other. Upon said continued opening, an electrical device in accordance with the invention may be arranged on a surface having the screen facing in one direction for being viewed at. The screen may e.g. be directed towards an audience for showing a presentation. At such the electrical device is positioned simile like a stand. Accordingly, when the portions relative each other are in closed position the keyboard in the one portion and the display in the other portion faces each other. Opposite, when the portions relative each other are opened having an opening angle their between being greater than approximately 180 degrees, the keyboard and the display are faced away from each other.

According to another embodiment of the present invention, the third part may extend from said second level to a third level along the axis. The third part decreases along the axis towards the third level. The first friction surface is adopted upon a continued opening to slide over a top portion between the second and the third part. Said axis may e.g. be a centre axis.

According to another embodiment of the present invention, the third level may be arranged at a level equal to the first level along the centre axis. When the hinge arrangement is opened such that theirs outer parts face each other, the third part has guided the first friction surface towards back to the first level along the axis.

According to another embodiment of the present invention, when opening the portions the first constant torque may be transformed to the second increased torque. The constant torque is achieved as a constant friction force between the first and second friction surfaces is obtained when said surfaces slide against each other. Said friction force is dependent upon a force from the resilient member against the plate. The second part affect sliding of the first friction surface such that for understanding it may be compared to a sliding of the first friction surface against an upwarded slope. The interaction between the element and the plate when sliding over said second part results in an increase of the resilient member against said plate. The increased is due to that the plate is being pushed towards the resilient member and thus decompressing the resilient member. A corresponding force equal to the force decompressing the resilient member is from the resilient member then affecting against the plate.

The resilient member may for instance be a coil spring, plate spring, wave shaped spring or a ring shaped spring.

According to another embodiment of the present invention, a third torque may precede the second torque upon opening the mobile phone. The third torque is reducing when the opening of the portions proceeds towards a total opening of the hinge arrangement. A total opening may be considered to represent approximately 360 degrees. The second torque transforms in to the third torque when the portions relative each other has an opening angle of approximately 180 degrees.

According to another embodiment of the present invention, level difference between said levels may have curved form. This has the effect that the sliding between the different parts may be made with a soft transition. A further effect of this that the curved form may prevent the first surface to get stuck between two parts upon turning/rotation of the element around said axis.

According to another embodiment of the present invention, the hinge arrangement may be for use in an electrical device.

The components of the hinge arrangement may be made from high-tensile steel. More particularly may the element, plate and an axis supporting the element be made by metal injection molding. The element may for instance be a gear, or other corresponding element arranged for transmission of a force or power. Alternatively, the element and the plate may be made from a polymeric material or ceramic material.

According to another embodiment of the present invention, a mobile electrical device having a first portion comprising at least one display and a second portion comprising at least one display and/or keyboard, said portions may be connected by means of a hinge according to above.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates a part of a hinge arrangement according to the invention;

FIG. 2 illustrates an exploded diagram of the arrangement according to FIG. 1;

FIG. 3 illustrates schematically internal components being arranged within a hinge arrangement partly illustrated in FIG. 1;

FIG. 4 illustrates an electronic device comprising a display and a keyboard, employing a hinge arrangement according to the invention;

FIG. 5 is a graphical modeling/diagram of a second friction surface according to the invention arranged at different levels along an axis, Y, with respect to the degree of an opening angle between moving portions relatively each other, X.

### DETAILED DESCRIPTION

In the following the invention is described with reference to a hinge and joint used in a device, especially a mobile phone. A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having two joint, hinged portions, such as a personal computer, a home entertainment system, a television, etc.

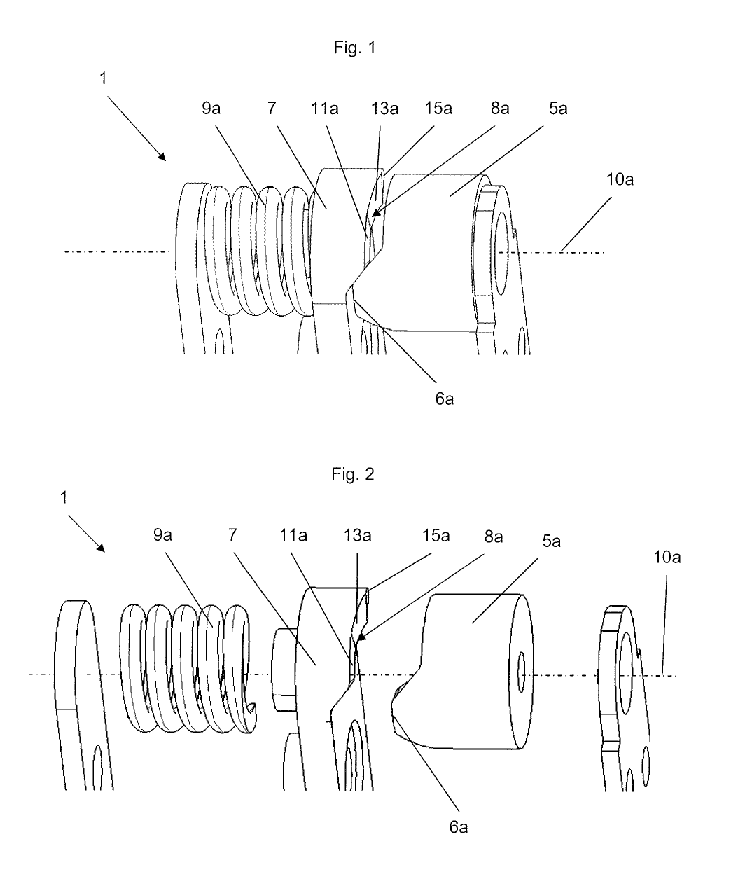

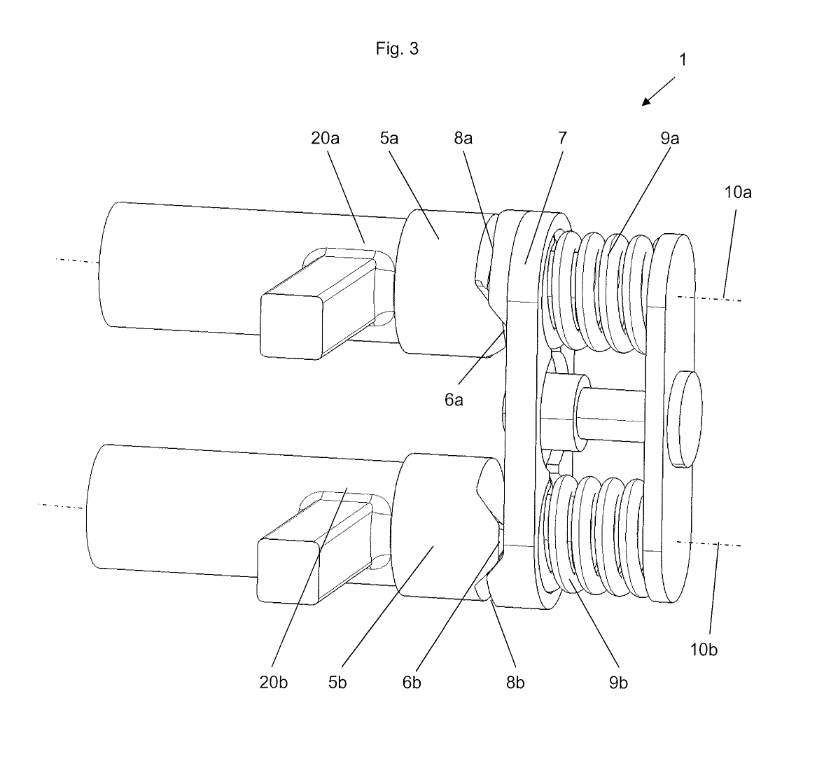

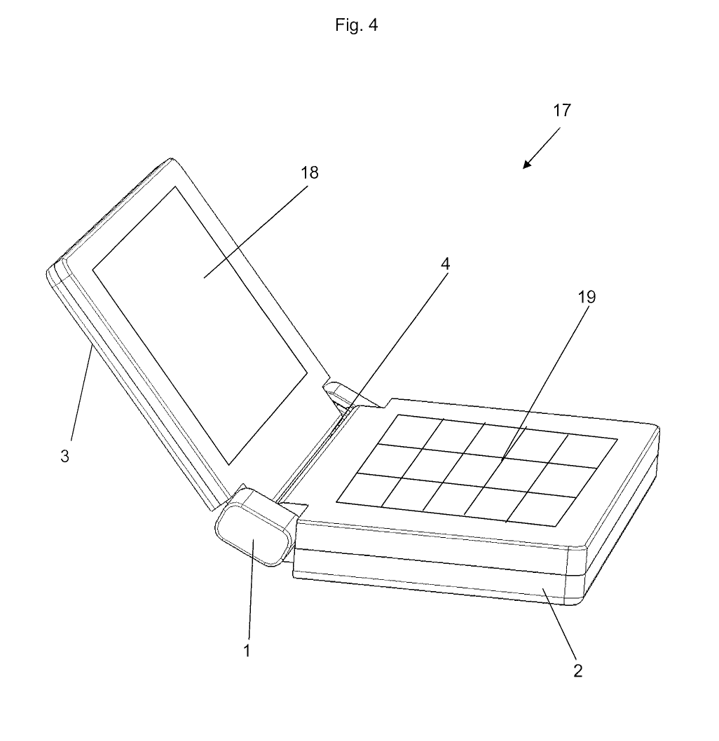

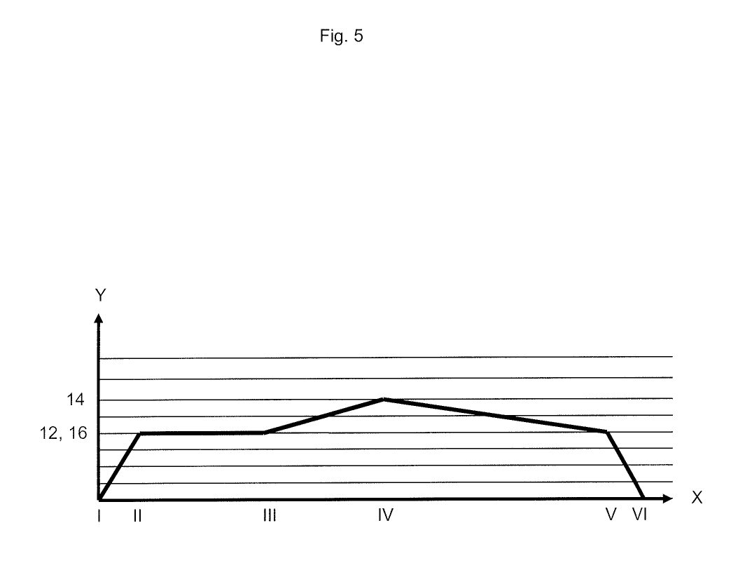

FIG. 1 and FIG. 2 illustrates part of a hinge arrangement 1 for assisting opening and closing two portions 2 and 3, (see FIG. 4) relative each other providing an opening angle between said portions 2, 3. FIG. 2 is an exploded diagram of the hinge arrangement 1 as illustrated in FIG. 1 in order to elucidate the components described and contained in FIG. 1. The hinge arrangement 1 is arranged at one end 4 (see FIG. 4) of the respective portion 2, 3. The hinge arrangement 1 comprises an element 5a having a first friction surface 6a. Adjacent to the element is a plate 7 arranged having a second friction surface 8a. The first friction surface 6a is adapted to slide against said second friction surface 8a. Further adjacent to the plate is a resilient member 9a arranged. The resilient member 9a is adapted to cooperate with the element 5a via the plate 7. The second friction surface 8a is arranged around, or partly around, an axis 10a through the element 5a. The axis may e.g. be a centre axis through the element 5a and plate 7. The second friction surface 8a comprises a first part 11a being arranged at a level along the axis 10a. Said level being defined as a first level 12. To elucidate the understanding of the levels reference is here and forth made to FIG. 5 showing a diagram how the levels of the second friction surface 8a are related to the axis 10a. The second friction surface 8a further comprises a second part 13a being arranged continuing from the first part 11a and having an extension from said first level 12 to a second level 14 along the axis 10a.

FIG. 3 illustrates a hinge arrangement 1, partly was illustrated in FIGS. 1 and 2. The hinge arrangement 1 in FIG. 3 comprises a second set of components corresponding to the components disclosed in FIGS. 1 and 2. The said second set of components, for elucidating and understanding, have for the same part the same reference number with the difference that it contains a “b” after the number instead of an “a”.

By using a second set of the components within the hinge arrangement 1 a sufficient torque within the hinge arrangement 1 may be achieved without the need for increasing the dimensions of the hinge arrangement 1. The turning/rotational movement of the respective element 5a, 5b, is synchronized with respect to each other via a synchronization unit, not shown in drawings. The synchronization unit is arranged such that within the hinge arrangement 1 by that the respective element 5a, 5b upon opening of the two portions 2, 3 the elements 5a, 5b have opposite turning/rotational directions. When opening the portions 2, 3 relatively each other, the respective element 5a, 5b with their respective first friction surface 6a, 6b, slides simultaneously against the corresponding second friction surface 8a, 8b. The respective second friction surface 8a, 8b is arranged at respective end part of the plate 7. The respective element 5a, 5b and resilient member 9a, 9b are each arranged along a respective axis 10a, 10b through the respective said element 5a, 5b and resilient member 9a, 9b. The axes 10a, 10b have a parallel extension with respect to each other. The respective element 5a, 5b is turnable/rotatable arranged with a respective fixation element 20a, 20b. The respective fixation element 20a, 20b, is each arranged in the end 4 connected to the respective portion 2, 3. The respective element 5a, 5b is supported by a shaft, not shown in drawing. Said axis 10a, 10b through the respective element 5a, 5b has an extension also through the respective shaft.

FIG. 4 illustrates an electrical device 17, e.g. a mobile electrical device, having a first portion 3 comprising a display 18. A second portion 2 of the electrical device 17 may comprise a display and/or a keyboard 19. The portions 2, 3 are connected to each other via the ends 4 of the respective portion 2, 3 by means of the hinge arrangement 1 as described in this disclosure and in relation to FIGS. 1-3. The hinge arrangement 1 is arranged to be able to have a continuing opening of the portions 2, 3 relative each other with an opening angle exceeding approximately 160-180 degrees towards a complete opening of approximately 360 degrees. The so called complete opening is defined as the portions 2, 3 relatively each other may have an opening angle being equal to approximately 360 degrees. At the opening angle being equal to approximately 360 degrees, the outer parts of the portions 2, 3 at this position may thus be facing against each other.

FIG. 5 illustrates graphically the second friction surface 8a, 8b being arranged at different levels along the axis 10a, 10b, Y, with respect to the degree of the opening angle between the portions 2, 3 relatively each other, X.

Alternatively, X may be represented by the turning/rotation angle of the element 5a, 5b around the axis 10a, 10b. In that case the alternative will be used, the below mentioned degrees needs to be divided by two as two sets of components are being used within the hinge arrangement 1 in the present invention. It should be noted that all angels mentioned in the description are given as example.

At point I, the portions 2, 3 are closed against each other having a 0 degree opening angle with respect to each other. At point II, the opening is initiated, thus the first friction surface 6a, 6b of the element 5a, 5b is leveled to an initial position on the second friction surface 8a, 8b. The initial position is arranged at a starting surface at one end of the first part 11a, 11b at the first level 12 along the axis 10a, 10b. The first part 11a, 11b is arranged at the first level 12 until the second part 13a, 13b commences. At point III along the axis of degree, X, the second part 13a, 13b has a pitch such that the pitch increases from the first level 12 to the second level 14 along and partly around the axis 10a, 10b. The opening angle between the portions 2, 3 is at point III approximately of about 70-100 degrees. At the point III along the degree of axis, X, the portions 2, 3 relatively each other has an opening angle corresponding to approximately about 160-180 degrees. At point IV along the axis X in the diagram is a top achieved/created. The top represents of being an upper meeting section/top where the second part 13 is transformed in to a third part 15. The third part 15 extends from said second level 14 to a third level 16 along the axis 10, Y. Said third level is equal to the first level 12. Point V represent an end of the third level 16, being equal to the first level 12. The point V represents approximately of that the portions 2, 3 at this point V relatively each other has an opening angle exceeding approximately 180 degrees. Preferably the opening is approximately within the range of 320-360 degrees. After the point V towards point VI the opening angle is about 360 degrees, whereby a total opening between the portions 2, 3 is achieved. The outer parts of the respective portion 2, 3 are at the point VI arranged adjacent each other.

Between point II and III the torque is constant. Between point III and IV is the torque increased during opening of the hinge arrangement 1 and/or upon the increase of the opening angle. Between IV and V is the torque decreasing during a continued opening of the hinge arrangement 1 and/or upon a continued increase of the opening angle. The increasing of the torque between point III and IV is such that the torque has a sufficient level of strength providing the portions not to flip back towards each other and simultaneously manage to withstand the force from being physically pointed and/or touched at.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

1. (canceled)

2-12. (canceled)

13. A hinge arrangement for opening and closing two portions connected to the hinge arrangement at one end, comprising:
an element having a first friction surface;
a plate having a second friction surface, wherein the first friction surface is adapted to slide against the second friction surface; and
a resilient member cooperating with the element,
wherein the second friction surface is arranged around, or partly around, an axis through the element such that the second friction surface comprises a first part arranged at a first level along the axis, and a second part arranged to extend from the first level to a second level along the axis.

14. The hinge arrangement of claim 13, wherein the second friction surface faces the element.

15. The hinge arrangement of claim 13, wherein the first friction surface is adapted to slide against the first part of the second friction surface with a constant torque applied to the hinge arrangement.

16. The hinge arrangement of claim 13, wherein the first friction surface is adapted to slide against the second part of the second friction surface with an increasing torque applied to the hinge arrangement.

17. The hinge arrangement of claim 13, wherein the second friction surface comprises a third part.

18. The hinge arrangement of any of claims 17, wherein the third part extends from said second level to a third level along the axis.

19. The hinge arrangement of claim 18, wherein the third level is arranged at a level equal to the first level along the axis.

20. The hinge arrangement of claim 13, wherein when opening the portions, a constant torque is transformed to an increasing torque.

21. The hinge arrangement of claim 13, wherein a third torque precedes the second torque upon opening the two portions.

22. The hinge arrangement of claim 13, wherein level difference between the first and second levels has a curved form.

23. The hinge arrangement of claim 13, wherein the hinge arrangement includes an electrical device.

24. A mobile electrical device including:
a first portion having at least one display; and
a second portion comprising a display or a keyboard,
wherein the first and second portions are connected via The hinge arrangement of claim 13.
